(19) United States
(12) Patent Application Publication
(10) Pub. No.: US 2014/0096467 A1
(43) Pub. Date: Apr. 10, 2014

(54) MAGNETIC-LOCK PANEL MOUNTING APPARATUS, SYSTEMS AND METHODS

(71) Applicant: 3form, Inc., Salt Lake City, UT (US)

(72) Inventor: A. Chase Norton, Salt Lake CIty, UT (US)

(73) Assignee: 3form, Inc., Salt Lake City, UT (US)

(21) Appl. No.: 14/119,842

(22) PCT Filed: May 21, 2012
(86) PCT No.: PCT/US2012/038877

§ 371 Date: Nov. 22, 2013

Related U.S. Application Data
(60) Provisional application No. 61/491,467, filed on May 31, 2011.

(51) Int. Cl. F16M 13/02

(52) U.S. Cl. CPC F16M 13/02
USPC 52/582.2; 29/426.1; 248/206.5

(57) ABSTRACT

Magnetic-lock panel mounting assemblies allow mounting, dismounting, and reconfiguration of decorative architectural resin panels relative to a support structure in a quick and efficient manner. The magnetic-lock panel mounting assemblies can include a housing, a locking pin, a locking sleeve, and one or more locking elements. The housing can receive and selectively lock the locking pin therein. Placing a magnet proximate the magnetic-lock panel mounting assembly can automatically unlock the locking pin from the housing. In addition, implementations of the present invention include systems and methods for mounting panels to a support structures using one or more magnetic-lock panel mounting assemblies.

### CROSS-REFERENCE TO RELATED APPLICATIONS

The present invention is a 35 U.S.C. §371 U.S. National Stage of PCT Application No. PCT/US2012/038877 entitled “Magnetic-Lock Panel Mounting Apparatus, Systems and Methods” filed May 21, 2012, which claims priority to U.S. Provisional Patent Application No. 61/491,467 entitled “Magnetic-Lock Panel Mounting Apparatus Systems, and Methods,” filed May 31, 2011. The entire content of each of the aforementioned patent applications is incorporated herein by reference.

### BACKGROUND OF THE INVENTION

1. The Field of the Invention

This invention relates to systems, methods, and apparatus for mounting and/or displaying panels as partitions, displays, barriers, treatments, or other structures.

2. Background and Relevant Art

Recent trends in building design involve adding to the functional and/or aesthetic characteristics of a given structure or design space by mounting one or more decorative panels thereto. This is at least partly since there is sometimes more flexibility with how the panel (or set of panels) is designed, compared with the original structure. Such decorative panels often include glass or resin sheets with a decorative image layer embedded therein or therebetween. Panels formed from resin materials are particularly popular because they tend to be less expensive in most applications than materials such as glass or the like, where certain structural, optical, and aesthetic characteristics are desired. In addition, resin materials tend to be more flexible in terms of manufacture and assembly because they can be relatively easily bent, molded, colored, shaped, cut, and modified in many different ways. Decorative resins can also provide more flexibility compared with glass and other conventional materials at least in terms of color, degree of texture, gauge, and impact resistance. Additionally, decorative resins have a fairly wide utility since they may be formed to include a large variety of colors, images, and shapes.

Unfortunately, conventional mounting systems and hardware used to mount such panels tend to suffer from a number of drawbacks. For example, mounting panels to a wall or other support structure using such conventional hardware systems can be difficult and labor intensive. For example, one conventional type of mounting system used to secure panels to a support structure (e.g., wall, ceiling, or frame) uses one or more standoffs. In general, a standoff positions a panel at a “standoff” (or extended) position with respect to the support structure. In particular, after mounting a standoff to a support structure, an assembler is typically required to hold the panel in a desired mounting position, attempt to align a perforation in the panel with the standoff, align and thread a screw through the perforation in the panel, and secure the screw to the standoff.

One will appreciate that this and similar panel mounting processes can be particularly difficult and cumbersome when using larger, heavier panels. Indeed, due to the awkwardness of conventional panel mounting hardware, installers can easily drop or otherwise damage panels during installation. Additionally, because conventional panel mounting systems often require complicated hardware and installation processes they typically do not allow for easy or quick assembly and disassembly. This can be problematic when the panels need to be regularly removed to allow for the changing of lighting bulbs, HVAC maintenance, etc.

Furthermore, when mounting panels to support structures using conventional standoffs, individual standoffs are often secured to the corners or edges of the panel one at a time. One will appreciate that this means a panel may be supported by only one or two standoffs during the installation process. This unbalanced support can cause increased concentration of stresses in the panel around these standoffs, which often leads to cracks and other panel damage. Additionally, when only one or two standoffs are secured to a panel it is easy for an installer to inadvertently bend the panel about such standoffs in an attempt to align further standoffs, which can cause panel damage.

The mounting of decorative panels using conventional hardware typically requires tools that may lead to panel damage. For example, conventional panel mounting hardware, such as standoffs, typically requires the use of a wrench or screw driver in close proximately to a panel for assembly. Wrenches and other large tools are often cumbersome to use and may lead to inadvertent panel damage. For instance, assemblers often scratch or otherwise damage panels during tightening of the hardware.

In addition to the foregoing, conventional mounting hardware often is unsightly, too noticeable, or does not provide an appropriate aesthetic for desired design environments. The unpleasant aesthetic of conventional mounting hardware is often magnified when used with translucent, transparent, or other panels that magnify texture, light, color, and form. Thus, conventional mounting hardware may be unappealing to designers and architects seeking to obtain a certain aesthetic by using decorative architectural panels.

In particular, this undesired aesthetic is often a result of mounting hardware, such as a conventional standoff cap, protruding from the panel surface. In addition to providing an undesirable aesthetic, protruding standoff caps can also present various functional drawbacks. For instance, conventional, protruding standoffs typically do not allow for a panel to be mounted as a wall, countertop, or step with a substantially smooth or flush surface. Furthermore, a protruding standoff cap may reduce the usable surface area of the panel, and create a protruding structure upon which objects (such as loosing clothing etc.) can easily catch or hook.

Accordingly, there are a number of disadvantages in conventional panel mounting systems and hardware that can be addressed.

### BRIEF SUMMARY OF THE INVENTION

Implementations of the present invention solve one or more of the foregoing or other problems in the art with systems, methods, and apparatus for mounting panels as partitions, displays, barriers, treatments, or other structure with increased functional versatility. In particular, one or more implementations include magnetic-lock panel mounting systems and components for releasably securing a decorative architectural panel to a support structure. Such magnetic-lock panel mounting systems and components can allow panels to be quickly and efficiently assembled, disassembled, and reconfigured with relative ease. Accordingly, implementations of the present invention can allow panels to be easily adapted to the environment of use and provide a number of secure mounting options.

For example, one implementation of a magnetic-lock panel mounting assembly includes a locking pin and a housing configured to receive the locking pin therein. The magnetic-lock panel mounting assembly further includes a magnetic locking mechanism configured move between an unlocked position and a locked position to selectively lock the locking pin within the housing. At least a portion of the magnetic locking mechanism is magnetically attractable whereby a magnet placed proximate the magnetic locking mechanism causes the magnetic locking mechanism to automatically move into the unlocked configuration.

Additionally, an implementation of an architectural panel system includes a resin-based architectural panel having a front surface and an opposing rear surface. The architectural panel system also includes one or more magnetic-lock panel mounting assemblies securing the resin-based architectural panel to a support structure. Each of the magnetic-lock panel mounting assemblies includes a locking pin, a housing configured to receive the locking pin therein, and a panel connector. The panel connector has a first end connected to the rear surface of the resin-based architectural panel. The panel connector has a second end connected to one of the locking pin and the housing. Each of the magnetic-lock panel mounting assemblies further includes a magnetic locking mechanism configured to selectively lock the locking pin within the housing. At least a portion of the magnetic locking mechanism is magnetically attractable whereby a magnet placed against the front surface of the resin-based architectural panel opposite the magnetic locking mechanism automatically causes the magnetic locking mechanism to unlock the locking pin from the housing.

In addition to the foregoing, a method of dismounting a resin-based panel from a support structure involves placing a magnet proximate a front surface of the resin-based panel at a position opposite the magnetic-lock panel mounting assembly. Whereby a magnetic field of the magnet draws a locking sleeve of the magnetic-lock panel mounting assembly toward a rear surface of the resin-based panel thereby unlocking a locking pin of the magnetic-lock panel mounting assembly from a housing of the magnetic-lock panel mounting assembly. The method further involves moving the resin-based panel away from the support structure, thereby, pulling the locking pin out of the housing of the magnetic-lock panel mounting assembly.

Additional features and advantages of exemplary implementations of the present invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective-view of a panel secured by a magnetic-lock panel mounting assembly in accordance with one or more implementations of the present invention;

FIG. 2 illustrates an exploded-view of the magnetic-lock panel mounting assembly of FIG. 1;

FIG. 3 illustrates a side cross-sectional view of the magnetic-lock panel mounting assembly of FIG. 1 in a locked configuration;

FIG. 4 illustrates a side cross-sectional view of the magnetic-lock panel mounting assembly of FIG. 1 in an un-locked configuration;

FIG. 5 illustrates a side cross-sectional view of another magnetic-lock panel mounting assembly in a locked configuration in accordance with one or more implementations of the present invention;

FIG. 6 illustrates a side cross-sectional view of the magnetic-lock panel mounting assembly of FIG. 5 in an un-locked configuration; and

FIG. 7 illustrates a schematic of a panel system including a plurality of panels secured to a support surface via a plurality of magnetic-lock panel mounting assemblies in accordance with one or more implementations of the present invention.

### DETAILED DESCRIPTION OF THE PREFERRED EMBODIMENTS

Implementations of the present invention provide systems, methods, and apparatus for mounting panels as partitions, displays, barriers, treatments, or other structure with increased functional versatility. In particular, one or more implementations include magnetic-lock panel mounting systems and components for releasably securing a decorative architectural panel to a support structure. Such magnetic-lock panel mounting systems and components can allow panels to be quickly and efficiently assembled, disassembled, and reconfigured with relative ease. Accordingly, implementations of the present invention can allow panels to be easily adapted to the environment of use and provide a number of secure mounting options.

Accordingly, one will appreciate from the description herein that the components of the present invention can significantly reduce the time and labor needed to mount and/or dismount panels to a structure. For instance, the magnetic-lock panel mounting assembly of the present invention can allow an installer to mount a panel to a support structure by pressing mounting components together that are configured with a magnetic-lock engagement. Similarly, an installer can disassemble a panel from a support structure by placing a magnet proximate the magnetic-lock panel mounting assembly to release the magnetic-lock mechanism holding the mounting components together.

Additionally, implementations of the present invention provide mounting hardware that, while capable of securely mounting panels, reduces or eliminates the visibility of hardware. For example, the magnetic-lock panel mounting systems of the present invention can securely mount panels to a support structure without covering or otherwise obscuring any portion of the surfaces of the panels being displayed (i.e., the proximal display surface). Indeed, in one or more implementations all of the hardware supporting a panel can be positioned behind the panel, and thus, obscured from view. Thus, the magnetic-lock panel mounting systems of the present invention can help magnify the aesthetic features of the mounted panels.

Furthermore, one will appreciate from the description herein that the components of the present invention can significantly reduce the likelihood of damaging the panels, in addition to providing a secure mount of the panels to a structure. For instance, one or more implementations allow an installer to mount a panel to a support structure by pressing mounting component(s) secured to the panel together with corresponding mounting component(s) secured to the support structure. Thus, the magnetic-lock panel mounting assemblies of the present invention may not require the use of tools in close proximity to a panel, which can easily scratch the panel during conventional installation processes.

As mentioned above, installer (architects, designers, assemblers, etc.) may choose to use components of the present invention to mount resin panels because they can allow resin panels to be quickly and easily mounted with a reduced likelihood of damage, while also providing a pleasing aesthetic. As used herein, the terms “resin panel” and “resin-based panel” refer to panels comprising a substrate of one or more layers or sheets formed from any one of the following thermoplastic polymers (or alloys thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like.

As a preliminary matter, implementations of the present invention are described herein primarily with reference to mounting panels, such as resin panels. One will appreciate, however, that a panel, particularly a resin-based panel, is only one type of “structure” with which the magnetic-lock panel mounting assemblies described herein are useable. For example, the magnetic-lock panel mounting assemblies of the present invention can mount not only resin “panels,” as such, but also glass panels, to a given support structure. Furthermore, one will appreciate that the magnetic-lock panel mounting assemblies can also be used to mount other types of structures having different material compositions, such as objects comprising wood, stone, fiberglass, or the like, which may or may not exhibit primarily panel-like dimensions as described herein. Reference herein, therefore, to panels, or even resin panels, as such, is primarily for convenience in description.

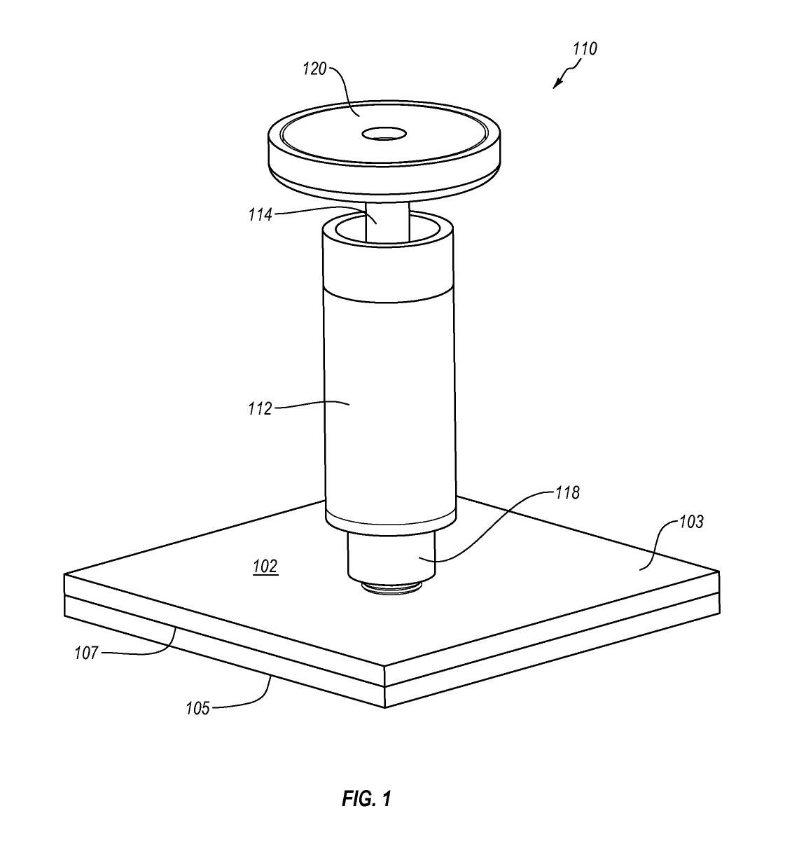

Referring now to the Figures, FIGS. 1-4 illustrate various views of a magnetic-lock panel mounting assembly 110 according to an implementation of the present invention. As mentioned above, the magnetic-lock panel mounting assembly 110 can securely mount one or more panels 102 to a support structure, while allowing the panels 102 to be quickly and efficiently assembled, disassembled, and reconfigured with relative ease. This is possible at least in part because the magnetic-lock panel mounting assembly 110 may not require the use of multiple fasteners or other mounting hardware that require time and significant effort to use. In contrast, the magnetic-lock panel mounting assembly 110 can allow an installer to easily mount a panel to a support surface as explained in greater detail below.

For example, FIG. 1 illustrates that the magnetic-lock panel mounting assembly 110 can comprise a housing 112 and a locking pin 114. As explained in greater detail below, an installer can selectably lock the locking pin 114 within the housing 112 to secure the resin-based panel 102 to a support structure. More specifically, when an installer inserts the locking pin 114 within the housing 112 and presses the locking pin 114 and housing 112 together, the locking pin 114 can automatically lock within the housing 112.

Thus, in order to secure resin-based panel 102, or a portion thereof, to a support structure, an installer can secure one of the housing 112 and the locking pin 114 to the resin-based panel 102, and the other of the housing 112 and the locking pin 114 to a support structure (such as a floor, wall, ceiling or other structure). The installer can then insert the locking pin 114 within the housing 112 and press the locking pin 114 and the housing 112 together, thereby locking the locking pin 114 within the housing 112 and securing the resin-based panel 102 to the support structure. In order to dismount the resin-based panel 102 from the support structure, the installer can position a magnet proximate the end of the magnetic-lock panel mounting assembly 110 secured to the panel 102. The magnet can cause the magnetic-lock panel mounting assembly 110 to automatically unlock. Once unlocked from the housing 112, the installer can pull the locking pin 114 out of the housing 112; and thus, dismount the resin-based panel 102 from the support structure.

As shown in FIG. 1, the magnetic-lock panel mounting assembly 110 can comprise a housing 112, a locking pin 114, and a mounting plate 120. Both the housing 112 and the locking pin 114 can be formed from a strong, light-weight material. For example, according to one or more implementations of the present invention, the housing 112 and the locking pin 114 can each be formed from a polymer, or a metal or alloy thereof, such as for example, aluminum. Indeed, according to some implementations of the present invention, the housing 112 and/or the locking pin 114 can be formed from a single piece of metal or other composite. One will appreciate, however, that these and other components described herein can be prepared from any number of synthetic or naturally occurring resins, rubbers, glass, ceramics, and/or composites thereof.

As mentioned before, the magnetic-lock panel mounting assembly 110 can secure a panel 102 to a support structure. One will appreciate that the panel 102 can have at least one surface that is displayed or visible to a viewer. In other words, because the back surface 103 of the panel 102 is secured to the proximal end of the magnetic-lock panel mounting assembly 110, the front surface 105, opposite to which the magnetic-lock panel mounting assembly 110 is secured, is visible to a viewer. Accordingly, the panel 102 can be configured to provide a desired aesthetic.

For example, the panel 102 can be transparent, translucent, and/or colored, as desired. When transparent or translucent resin-based panels 102 are used, the magnetic-lock panel mounting assembly 110 can be at least partially (if not entirely) hidden from view at least in part since none of the components of the magnetic-lock panel mounting assembly 110 extend completely through any such panel 102 (e.g., via any perforations therein). Furthermore, an installer can form the resin-based panels 102 to include embedded two or three-dimensional objects such as thatch, willow reed, coffee beans, bamboo, and similar objects in order to provide a desired aesthetic. For example, FIG. 1 illustrates that the panel 102 includes a decorative image layer 107. The decorative image layer 107 can comprise a film or fabric, and can at least partially conceal the magnetic-lock panel mounting assembly 110 from being visible through the front surface 105 of the resin-based panel 102. Thus, one will appreciate that an installer can create a desired aesthetic for the panel 102 including any number or combinations of different features (e.g., color, transparency, surface texture, embedded objects, or printed images). Furthermore, an installer can mount a variety of panels each with similar or different aesthetic features to provide a desired overall aesthetic.

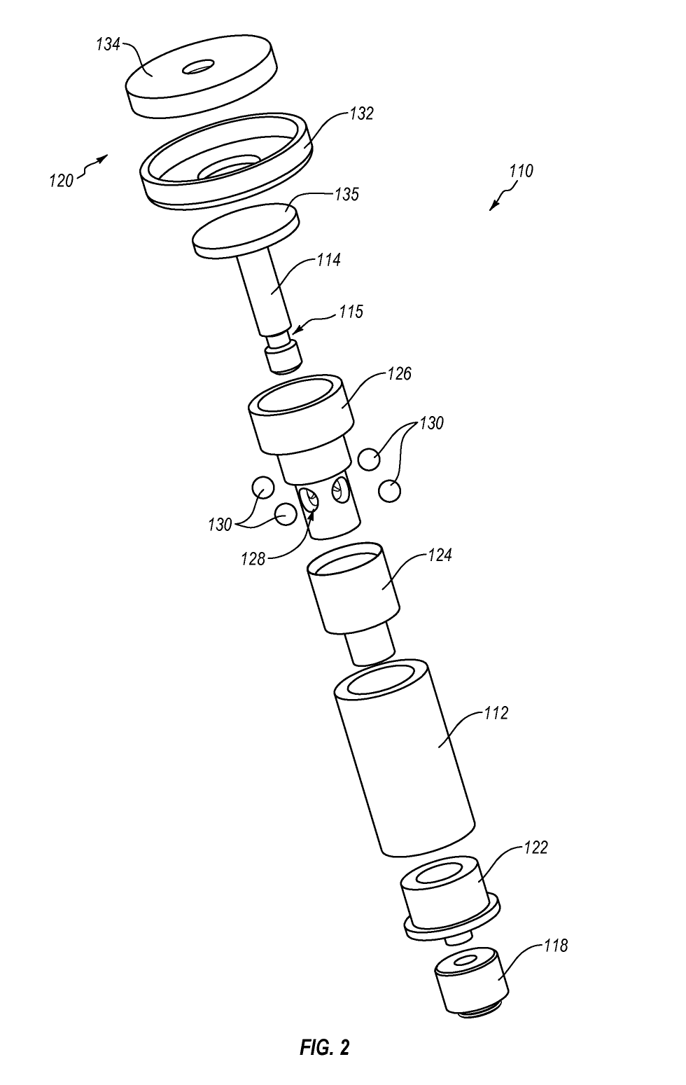

As shown in FIG. 2, the housing 112 can comprise a generally cylindrical, hollow member. One will appreciate that the housing 112 can secure the panel 102 at a standoff from a support surface. The height of the housing 112 can correspond to a desired standoff length. For example, according to one or more implementations of the present invention, no standoff may be desired and the housing 112 can have a reduced height from that shown in the Figures. According to alternative implementations, a larger standoff may be desired to create a desired acoustic, heating, visual, or other functional or aesthetic effect.

For instance, in one or more implementations a panel system can include lights positioned behind the panel 102, which backlight the panel 102. In such implementations, it may be desirable to use a housing 112 with a greater height to help ensure that the various components of the magnetic-lock panel mounting assembly 110 (or their shadows) cannot be seen through the panel 102. Additionally, the panel 102, or the back surface 103 of the panel 102, can include a diffuser film (not shown) to help evenly distribute light across the panel 102. In such implementations, it may be desirable to use a housing 112 with a greater height to help ensure there is enough space to effectively diffuse the light. According to yet additional implementations of the present invention, it may be desirable to use a housing 112 with a greater height to help create an acoustic effect, create space for storing a backlight or other components, or provide increased insulation. According to one or more implementations of the present invention the height of the magnetic-lock panel mounting assembly 110 can also or alternatively be increased by increasing the length of the locking pin 114.

Thus, one will appreciate in light of the disclosure herein that the magnetic-lock panel mounting assembly 110 can include a first end configured to be secured to a resin-based panel 102. For example, as shown in FIG. 1, the magnetic-lock panel mounting assembly 110 can include a panel mounting connector 118 configured to secure one end to the resin-based panel 102. In at least one implementation the panel mounting connector 118 can comprise a melt-bondable panel mounting bracket, such as that described in U.S. Patent Application Publication Number 2011/0214379 (Ser. No. 13/129,239), the entire contents of which are hereby incorporated by reference.

The melt-bondable panel mounting bracket can allow an installer to secure the magnetic-lock panel mounting assembly 110 to the resin-based panel 102, while also hiding or concealing any hardware from a front surface 105 of the resin-based panel 102. For example, in one or more implementations the melt-bondable panel mounting bracket is embedded into the resin of the back surface 103 of the panel 102. In such implementations, the melt-bondable panel mounting bracket may not extend all the way through the panel 102 to the front surface 105. Thus, the front surface 105 of the panel 102 can be devoid of holes or hardware.

Alternatively, the panel mounting connector 118 can include a standoff screw and cap, a bracket, a flange, an adhesive, or other suitable hardware component capable of securing the magnetic-lock panel mounting assembly 110 to a panel 102. In such implementations, the front surface 105 of the panel 102 may include hardware (i.e., a standoff cap).

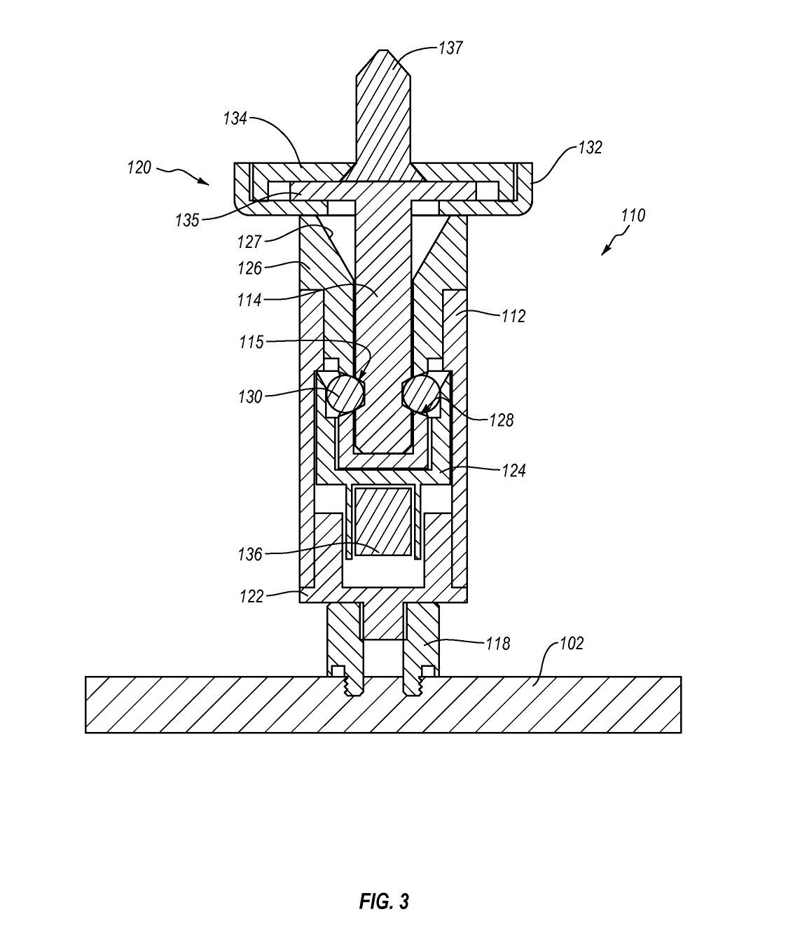

Additionally, the magnetic-lock panel mounting assembly 110 can include a second end configured for connecting to a support structure. For example, as shown in FIG. 1, the magnetic-lock panel mounting assembly 110 can include a mounting plate 120 configured to secure the locking pin 114 to a support structure. As shown by FIG. 2, the mounting plate 120 can include a plate 134 and a cover 132. An installer can secure the plate 134 to a support surface via a fastener 137 (see FIG. 3). The installer can then place the head 135 of the locking pin 114 within the cover 132. The installer can then secure the cover 132 to the plate 134. The cover 132 and plate 134 can mate via a threaded interface, a snap-fit engagement, or other connection mechanism. In alternative implementations, the mounting plate 120 can include a screw, a flange, an anchor, an adhesive, or other suitable hardware component capable of securing the magnetic-lock panel mounting assembly 110 to a support structure.

The magnetic-lock panel mounting assembly 110 need not include a mounting plate 120. Indeed, in alternative implementations, the locking pin 114 can attached directly to an anchor in a support surface or to a support surface itself. For example, in one or more implementations instead of a head 135, the locking pin 114 can include a threaded end for attaching to an anchor or other hardware component. Thus, one will appreciate in light of the disclosure herein that the magnetic-lock panel mounting assembly 110 can include any number of different configurations for attaching to a support structure.

Referring again to FIG. 2, the magnetic-lock panel mounting assembly 110 can also include a base 122. The base 122 can couple the housing 112 to the panel mounting connector 118. For example, the panel mounting connector 118 can have internal threads or external threads that can correspond to threads on the proximal end of the base 122. Thus, the panel mounting connector 118 can have a threaded engagement with the base 122. Alternatively, the panel mounting connector 118 can connect to the base 122 by a locking pin, a set screw, a snap-fit engagement, or other fastener.

In alternative implementations, the panel connector 118 is directly connected to the housing 112 or the locking pin 114. For example, in one or more implementations the panel connector 118 can include threads configured to mate with corresponding threads on the housing 112 or locking pin 114. Thus, one will appreciate in light of the disclosure herein that the magnetic-lock panel mounting assembly 110 can include any number of different configurations for attaching to the panel connector 118.

In addition to the foregoing, the magnetic-lock panel mounting assembly 110 can further include a magnetic locking mechanism configured to selectively lock the locking pin 114 within the housing 112. For example, FIG. 2 illustrates that the magnetic locking mechanism can include a locking sleeve 124, a retainer 126, and a plurality of locking elements 130. As explained in greater detail below, the locking elements 130 can move into a groove 115 of the locking pin 114 to lock the locking pin 114 within the housing 112. The locking elements 130 can move radially outward away from the locking pin 114 into tapered holes 128 in the retainer 126 to unlock the locking pin 114 relative to the housing 112. Thus, the magnetic locking mechanism can move between an unlocked position and a locked position to selectively lock the locking pin 114 within the housing 112.

As mentioned above, the locking pin 114 can include one or more grooves 115 in which one or more locking elements 130 can extend to lock the locking pin 114 within the housing 112. FIG. 2 illustrates that the groove 115 comprises a single annular groove that extends radially into the locking pin 114. The single annular groove 115 can hold a plurality of locking elements 130. Furthermore, by extending completely around the locking pin 114, the single annular groove 115 can ensure that the locking pin 114 will engage the locking elements 130 irrespective of the orientation of the locking pin 114. In alternative implementations, the locking groove 115 can comprise a plurality of grooves that are each sized and configured to hold a single locking element 130.

FIG. 2 illustrates that the magnetic locking mechanism can include four locking elements 130. One will appreciate in light of the disclosure herein that the present invention is not so limited. For example, in alternative implementations the magnetic locking mechanism can include a single locking element 130. In still further implementations, the magnetic locking mechanism can comprise two, three, five, six, or more locking elements 130. The locking elements 130 can comprise ball bearings as shown in the figures. In alternative implementations, the locking elements can be wedged shaped, pins, or other shapes and/or configurations.

As mentioned previously, the locking elements 130 can reside within tapered holes 128 in the retainer 126. The retainer 126 can help ensure that the locking elements 130 do not fall out of the housing 112 or otherwise move out of position. The tapered holes 128 can angle radially outward and axially toward the panel connector 118. As explained in greater detail below, the axial taper of the tapered holes 128 can cause the locking elements 130 to move out of the groove 115 in the locking pin 114 when the magnetic locking mechanism is in the unlocked position.

FIG. 3 illustrates a side cross-sectional view of the magnetic-lock panel mounting assembly 110 in a locked position. As shown, when in the locked position, the locking elements 130 are wedged into the groove 115 of the locking pin 114. In particular, the locking sleeve 124 is moved away from the panel connector 118. An annular tapered end of the locking sleeve 124 forces the locking elements 130 radially into the groove 115. When the locking elements 130 are wedged between the locking sleeve 124 and the groove 115, the locking elements 130 prevent the locking pin 114 from being removed from the housing 112 or otherwise moving relative to the retainer 126 or the housing 112. Thus, as described above, once in the locked position, the magnetic locking mechanism can prevent the locking pin 114 from being removed from the housing 112 or retainer 126.

To mount the panel 102 to a support surface, an installer can secure a mounting bracket 120 either directly or indirectly to a support structure (i.e., wall, ceiling, floor etc.). For example, the installer can secure a plate 134 of the mounting bracket 120 directly to the support structure via a fastener 137 or anchor. One will appreciate in light of the disclosure herein that the installer can select an appropriate anchor based on the type of support structure (i.e., wood, concrete, drywall etc.) to (or within) which the anchor is secured.

The installer can then place the head 135 of the locking pin 114 against the plate 137. The installer can then secure the cover 132 to the plate 134 to secure the locking pin 114 to the support surface via the mounting plate 120. For example, in one or more implementations the installer can thread the cover 132 to the plate 134. Alternatively, the cover 132 and plate 134 can have a snap-fit or interference fit configuration.

According to additional implementations of the present invention, an installer can secure the mounting bracket 120 indirectly to the support structure 106 via a mounting plate, flange, frame, or other intermediate structure. For example, according to one or more implementations, the installer can secure the mounting bracket 120 to an extruded frame, which can in turn be secured to the support structure.

The installer can then secure the panel connector 118 to the resin-based panel 102. As shown in FIG. 3, then the panel connector 118 comprises a melt-bondable panel mounting bracket, the installer can heat and then insert melt-bondable panel mounting bracket 118 directly into a surface of the resin-based panel 102. One will appreciate that the temperature to which the installer heats the melt-bondable panel mounting bracket 118 can vary depending upon the type of resin-based panel 102 used. For example, a user can heat the melt-bondable panel mounting bracket 108 to a temperature between about 150 degrees Fahrenheit and about 400 degrees Fahrenheit. Once heated, the installer can apply approximately 50 psi to approximately 300 psi to the melt-bondable panel mounting bracket 118 to force the melt-bondable panel mounting bracket 118 into a panel 102. In additional implementations, the installer can heat the melt-bondable panel mounting bracket 118 to a temperature of between about 100 and about 500 degrees Fahrenheit and apply between approximately 20 psi and approximately 100 psi to bond the melt-bondable panel mounting bracket 118 to a panel 102.

As the installer inserts the heated melt-bondable panel mounting bracket 118 into a resin-based panel 102, the resin can melt and can flow into the bonding recesses and around the bonding ridges. The resin of the resin-based panel 102 can then solidify, thereby sealing the bonding protrusions into the resin-based panel 102. Thus, the bonding recesses in combination with the ridges can help mechanically prevent the melt-bondable panel mounting bracket 118 from being pulled out of the resin of a resin-based panel 102.

In any case, upon securing opposing ends of the magnetic-lock panel mounting assembly 110 to the panel 102 and the support structure 106, the installer can secure the housing 112 and the locking pin 114 together. In particular, the installer can press the housing 112 about the locking pin 114. For example, the installer can align the open end of the retainer 126 with the locking pin 114 can push the retainer 126 and housing 112 about the locking pin 114.

As shown by FIG. 3, the open end of the retainer 126 can include a tapered inner surface 127. In particular, the tapered inner surface 127 can extend radially inward and axially toward the panel connector 118. The tapered inner surface 127 of the retainer 126 can help guide the locking pin 114 into the retainer 126 and the housing 112. More specifically, the tapered inner surface 127 of the retainer 126 can help ensure that as an installer presses housing 112 and the retainer 126 toward the locking pin 114, that the locking pin 114 will enter into the retainer 126 even if the installer has not completely aligned the locking pin 114 and the opening of the retainer 126.

Once the locking pin 114 is fully inserted within the retainer 126 and housing 112 as illustrated by FIG. 3, the locking elements 130 can automatically wedge into the groove 115, thereby locking the locking pin 114 within the housing 112. The magnetic-lock panel mounting assembly 110 can be biased toward the locked configuration shown in FIG. 3. For example, a biasing mechanism can bias the locking sleeve 124 away from the panel connector 118; thereby biasing the locking elements 130 radially inward. The biasing mechanism can comprise a spring, magnetic field, or other mechanism capable of biasing the locking sleeve 124 away from the panel connector 118.

For instance, FIG. 3 illustrates that the magnetic locking mechanism can include a magnetically attractable element 136 coupled to the locking sleeve 124. Additionally, the retainer 126 can be magnetized. The magnetic force or attraction between the magnetically attractable element 136 and the retainer 126 can cause the locking sleeve 124 to move toward the retainer 126. Movement of the locking sleeve 124 toward the retainer 126 can force or wedge the locking elements 130 into the groove 115; thereby unlocking the locking pin 114 from the housing 112.

In order to secure a panel 102 to a support surface 100, an installer can position multiple magnetic-lock panel mounting assemblies 110 about the panel 102. For example, the thinner the gauge of panel 102 used, the fewer the number of support locations needed to hold the weight of the panel 102; however, the greater the number of support locations needed to prevent deflection of the panel 102. On the other hand, the thicker the gauge of panel 102, the greater the number of support locations needed to hold the weight of the panel 102; but the lesser the number of support locations needed to prevent defection of the panel 102. In any case, according to some implementations of the present invention, the installer can push multiple locking pins 114 with multiple housings 112 at the same time. Thus, the installer need not have to attempt to align various hardware components (such as a threaded rod and washers etc) with a mounting through-hole in the panel 102, all while supporting the weight of the panel 102 and attempting to tighten a cap or other fastener.

Thus, once a panel 102 is secured to one end of the magnetic-lock panel mounting assembly 110, and the opposite end is secured to a support surface, all an installer need do to secure the panel 102 to the support structure is insert the locking pin 114 into the housing 112, thereby causing the locking pin 114 to lock within the housing 112. Thus, when the support surface 106 is a ceiling or other overhead structure, all an installer need do to secure the panel 102 to the ceiling is insert the locking pin 114 into the housing 112.

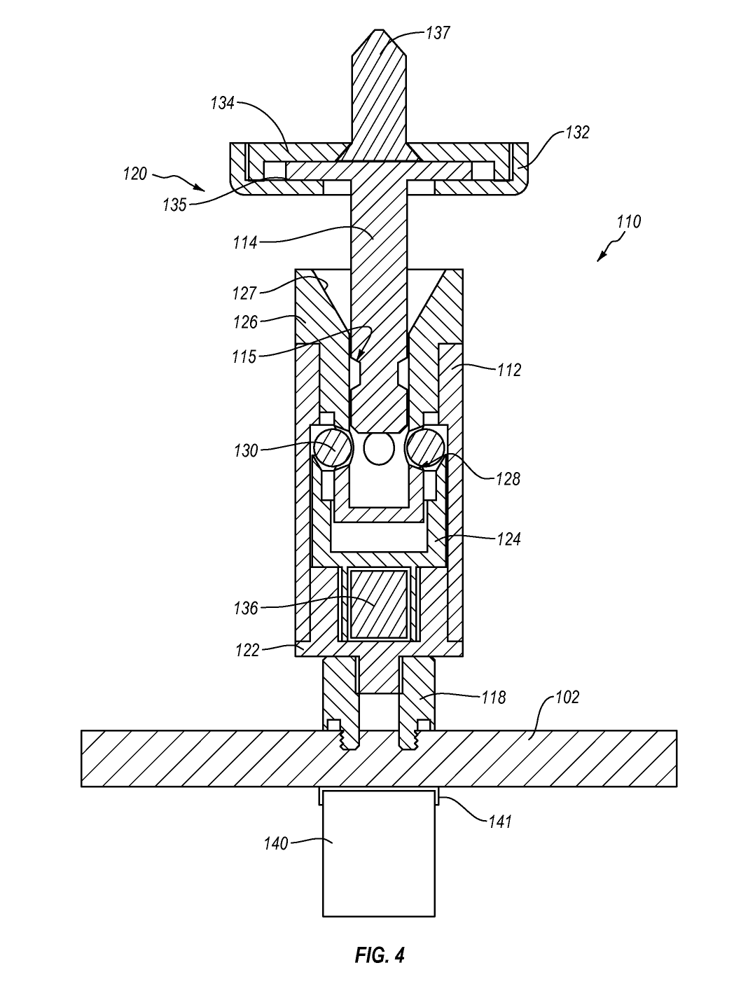

FIG. 4 illustrates a side cross-sectional view of the magnetic-lock panel mounting assembly 110 in the un-locked configuration. To move the magnetic-lock panel mounting assembly 110 from the locked position (FIG. 3) to the unlocked position (FIG. 4), an installer can place or locate a magnet 140 proximate the portion of the panel 102 opposite the magnetic-lock panel mounting assembly 110. The magnet 140 can attract a magnetically attractable element 136 positioned within the magnetic-lock panel mounting assembly 110. The magnetic force or attraction between the magnetically attractable element 136 and the magnet 140 can cause the locking sleeve 124 to move toward the magnet 140 and away from the locking pin 114. Movement of the locking sleeve 124 toward the magnet 140 can cause the locking elements 130 to move radially outward of the groove 115; thereby unlocking the locking pin 114 from the housing 112.

In particular, the taper of the tapered holes 128 can cause the locking elements 130 to automatically roll or slide radially outward of the groove 115 once the locking sleeve 124 is pulled away by the magnetic force. Once the locking elements 130 have moved out of the groove 115, the installer can remove the locking pin 114 from the housing 112. In other words, an installer can retract the housing 112 from about the locking pin 114.

As shown in FIG. 4, in one or more implementations the magnetically attractable element 136 can reside within the locking sleeve 124. The magnetically attractable element 136 can comprise a magnet or a metal. In alternative implementations, the locking sleeve 124 itself may comprise the magnetically attractable element.

In still further implementations, the housing 112 is rigidly fixed to the locking sleeve 124. In such implementations, the housing 112 can move with the locking sleeve 124 between a proximal position (unlocked position) and a distal position (locked position). In such implementations, the housing 112 may comprise a metal or a magnet that is attractable to the magnet 140. Still further, a magnetically attractable element 136 is coupled to the inside or outside of the housing 112.

In any event, the magnetic-lock panel mounting assembly 110 can comprise a magnetically attractable element (e.g., 136) or component (e.g., 124, 112) that move under magnetic force toward a magnet 140 to unlock the magnetic-lock panel mounting assembly 110. One will appreciate in light of the disclosure herein that the magnetic force between the magnet 140 and the magnetically attractable element 136 can be sufficiently strong to overcome the biasing force created by the biasing mechanism (i.e., the magnetic force between the magnetically attractable element 136 and the retainer 126 or a spring).

In addition to allowing a panel 102 to be relatively easily mounted to a support structure 106, the magnetic-lock panel mounting assembly 110 can also allow a panel 102 to be relatively easily dismounted from a support structure 106. This can be particularly useful when there are backlights, electrical components, HVAC components, or other components behind the mounted panel 102 that need to be accessed from time to time. In order to dismount the panel 102 from the support structure 106, an installer can position the magnet 140 proximate the magnetic-lock panel mounting assembly 110 (albeit on the opposite side of the panel 102). The magnet 140 can cause the locking sleeve 124 to move proximally, thereby unlocking the locking pin 114 from the housing 112.

As shown by FIG. 4, in one or more implementations the magnet 140 can include a coating or shield 141. The coating or shield 141 can comprise a resilient material, such as natural or synthetic rubber. The coating or shield 141 can provide a barrier between the magnet 140 and the panel 102 to help reduce or eliminate the magnet 140 from scratching or otherwise damaging the panel 102.

Just as the magnetic-lock panel mounting assembly 110 can increase the ease with which an installer can mount a panel 102 to a support structure, the magnetic-lock panel mounting assembly 110 can also increase the ease with which an installer can dismount or reconfigure a mounted panel. According to one method of the present invention, an installer can dismount a panel 102 secured to a support structure 106 with relative ease. For example, a position a magnet against the panel 102 at each point where a magnetic-lock panel mounting assembly 110 is secured. The magnet force between the magnet 140 and the magnetically attractable element 136 can retain the magnet 140 against the panel 102. This can free up the hands of the installer, thereby allowing the installer to pull the panel 102 (and each of the housings 112) away from the support structure (and the locking pins 114 secured thereto) to dismount a panel 102.

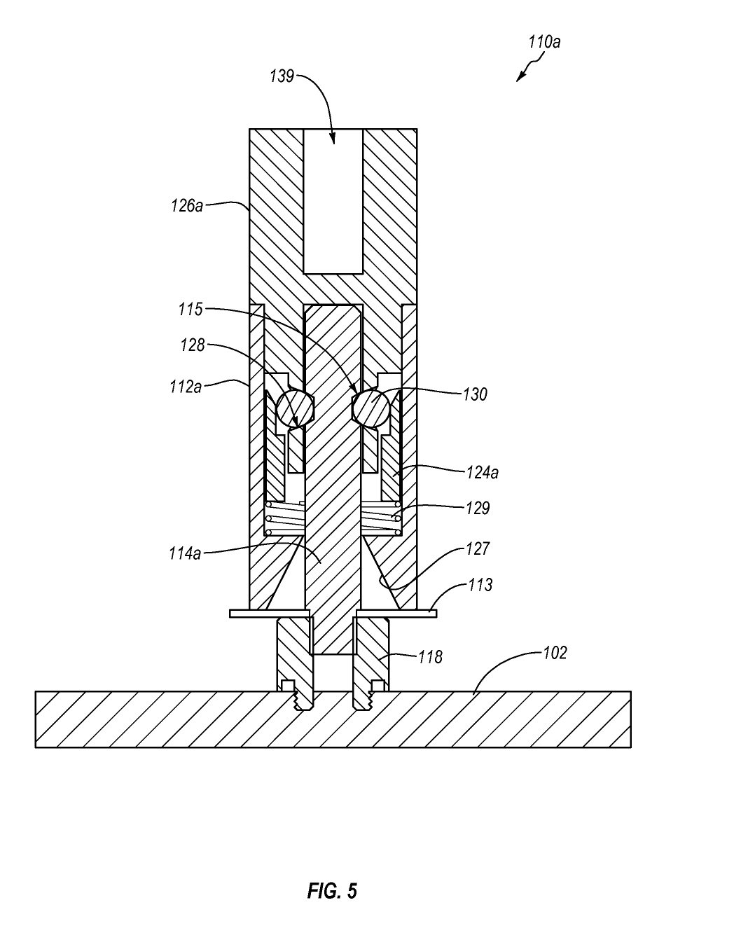

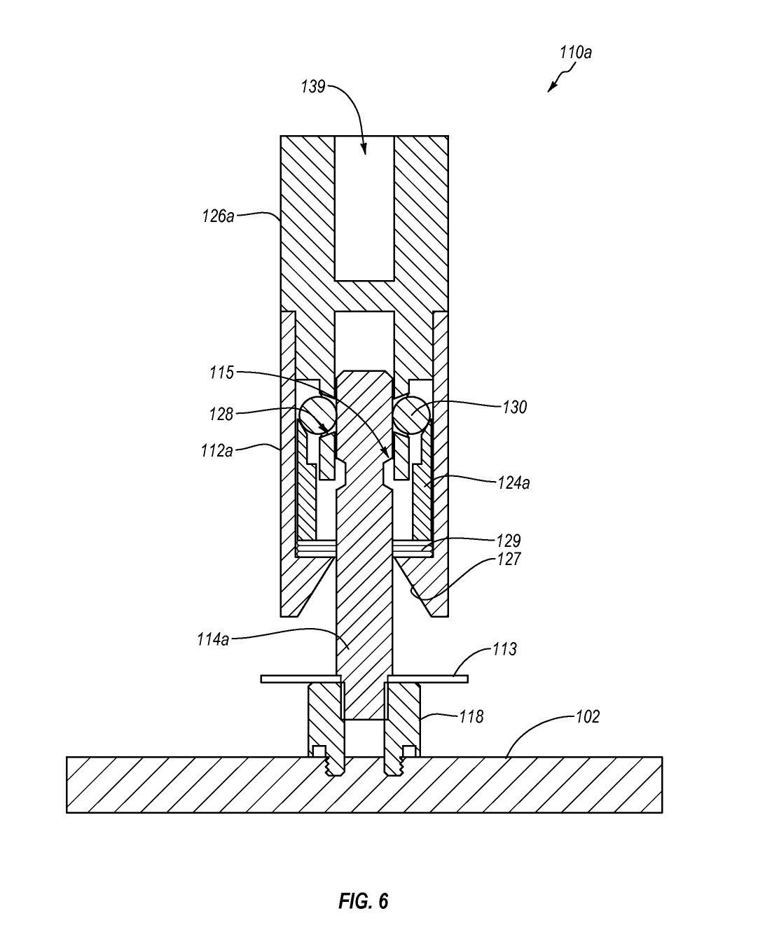

The magnetic-lock panel mounting assembly 110 illustrated in FIGS. 1-4 is configured to have a locking pin 114 attach to a support surface and a housing 112 attach to a panel 102. One will appreciate that the present invention is not so limited. For example, FIGS. 5 and 6 illustrate another implementation of a magnetic-lock panel mounting assembly 110a in which the locking pin 114a attaches to the panel 102 and the housing 112a attaches to the support surface.

The magnetic-lock panel mounting assembly 110a can include a panel connector 118 securable to a resin-based panel 102. An end of the locking pin 114a can attached directly to the panel connector 118. The locking pin 114a can include a groove 115 configured to receive locking elements 130 as described above.

FIG. 5 further illustrates that the retainer 126a can include a mounting bore 139. The mounting bore 139 can comprise a threaded receptacle that can allow an installer to secure the retainer 126a to a support structure (e.g., wall, ceiling, or floor) or other hardware, such as, but not limited to, an anchor, a frame, etc. The housing 112a can fixedly couple to the retainer 126a. Thus, an installer can mount the housing 112a and retainer 126a to a support structure, while attaching the locking pin 114a to a resin-based panel 102.

Similar to the magnetic-lock panel mounting assembly 110, the magnetic-lock panel mounting assembly 110a can include a locking sleeve 124a configured to move between an unlocked (FIG. 6) and a locked position (FIG. 5). In particular, the locking sleeve 124a can move relative to one or more of the housing 112a and the retainer 126a. For example, as illustrated by FIGS. 5 and 6, the locking sleeve 124a moves inside of the housing 112a along the retainer 126a.

The magnetic-lock panel mounting assembly 110a can further include a biasing mechanism 129 for biasing the locking sleeve 124a in the locked position (FIG. 5). By biasing the locking sleeve 124a away from the panel connector 118, the biasing member 129 can bias the locking elements 130 radially inward. Thus, when an installer inserts the locking pin 114a within the retainer 126a, the locking elements 130 can automatically move into the groove 115 of the locking pin 114, thereby, locking the locking pin 114a within the housing 112a.

As shown by FIG. 5, the open end of the housing 112a can include a tapered inner surface 127. In particular, the tapered inner surface 127 can extend radially inward and axially toward the retainer 126a. The tapered inner surface 127 of the housing 112a can help guide the locking pin 114 into the retainer 126a and the housing 112a. More specifically, the tapered inner surface 127 can help ensure that as an installer inserts the locking pin 114a into the housing 112a, the locking pin 114a will enter into the housing 112a even if the installer has not completely aligned the locking pin 114a and the opening of the housing 112a. The magnetic-lock panel mounting assembly 110a can also optionally include a washer 113 against which the housing 112a can abut when in the locked position (FIG. 5).

To move the magnetic-lock panel mounting assembly 110a from the locked position (FIG. 5) to the unlocked position (FIG. 6), an installer can place or locate a magnet 140 proximate the portion of the panel 102 opposite the magnetic-lock panel mounting assembly 110a. The magnet 140 can attract the locking sleeve 124a, which can comprise a magnetically attractable element or material. The magnetic force or attraction between the locking sleeve 124a and the magnet 140 can cause the locking sleeve 124a to move toward the magnet 140. Movement of the locking sleeve 124a toward the magnet 140 can cause the locking elements 130 to move radially outward of the groove 115; thereby unlocking the locking pin 114 from the housing 112 as described above.

In particular, the magnetic force between the magnet 140 and the locking sleeve 124a can be sufficiently strong to overcome the biasing force created by the biasing mechanism (i.e., spring 129). Thus, the magnetic force can cause the locking sleeve 124a to move toward the panel 102. Once the locking sleeve 124a moves toward the panel 102, the taper of the tapered holes 128 can cause the locking elements 130 to automatically roll or slide radially outward of the groove 115. Once the locking elements 130 have moved out of the groove 115, the installer can remove the locking pin 114a from the housing 112a.

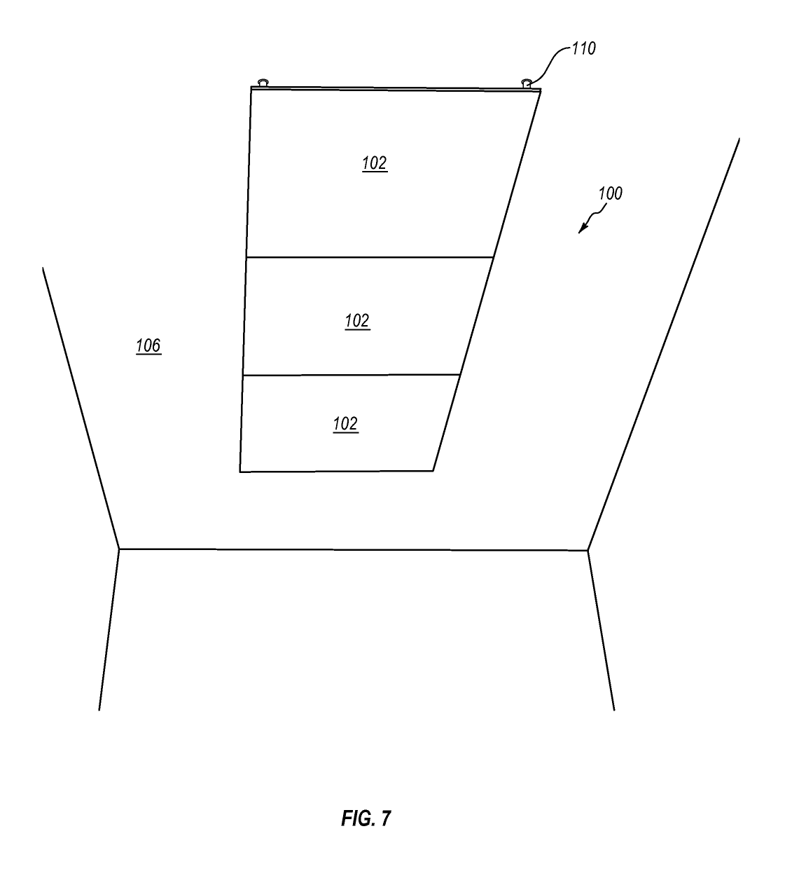

As mentioned previously, the magnetic-lock panel mounting assembly 110 can securely, yet releasably mount panels 102 to a support structure. For example, FIG. 7 illustrates a schematic diagram of a system 100 comprising a plurality of panels 102 mounted as a treatment to a support structure 106 (e.g., ceiling) via a plurality of magnetic-lock panel mounting assemblies 110. As discussed above, according to one or more implementations of the present invention, the magnetic-lock panel mounting assemblies 110 can secure the panels 102 to the support structure 106 in a manner that the visibility of the magnetic-lock panel mounting assemblies 110 is reduced or eliminated. For example as shown in FIG. 7, according to one or more implementations of the present invention no hardware protrudes from the display surface (i.e., the proximal, visible outside surface of the panels 102). According to alternative implementations of the present invention, however, a screw, standoff cap, or other portion of a panel mounting connector 118 may protrude from the display surface of a mounted panel 102.

As the forgoing methods illustrate, systems and components of the present invention can provide increased versatility in mounting panels. In particular, the systems and components of the present invention can allow panels to be secured to support structure using various components that allow for simple and fast assembly. Additionally, the systems and components of the present invention can help protect the panel from damage, while also providing a pleasing aesthetic.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A magnetic-lock panel mounting assembly for removably securing a panel to a support structure, comprising:
a locking pin;
a housing configured to receive the locking pin therein; and
a magnetic locking mechanism configured move between an unlocked position and a locked position to selectively lock the locking pin within the housing;
wherein at least a portion of the magnetic locking mechanism is magnetically attractable whereby a magnet placed proximate the magnetic locking mechanism causes the magnetic locking mechanism to automatically move into the unlocked configuration.

2. The magnetic-lock panel mounting assembly as recited in claim 1, wherein the magnetic locking mechanism comprises:
a locking sleeve configured to move relative to one or more of the locking pin and the housing; and
one or more locking elements positioned between the locking sleeve and the locking pin.

3. The magnetic-lock panel mounting assembly as recited in claim 2, wherein:
the locking pin comprises one or more grooves;
when in the locked position, the locking sleeve forces the one or more locking elements into the one or more grooves; and
the one or more locking elements automatically move out of the one or more grooves when the locking sleeve is in the unlocked configuration.

4. The magnetic-lock panel mounting assembly as recited in claim 3, wherein the locking elements comprise ball bearings.

5. The magnetic-lock panel mounting assembly as recited in claim 4, further comprising a retainer positioned within the housing, the retainer comprising tapered openings in which the locking elements are positioned.

6. The magnetic-lock panel mounting assembly as recited in claim 5, wherein the tapered openings cause the ball bearings to move out of the one or more grooves when the locking sleeve is in the unlocked position.

7. The magnetic-lock panel mounting assembly as recited in claim 2, further comprising a biasing mechanism configured to bias the locking mechanism toward the locked position.

8. The magnetic-lock panel mounting assembly as recited in claim 7, wherein the biasing mechanism comprises a spring positioned between the housing and the locking sleeve.

9. The magnetic-lock panel mounting assembly as recited in claim 2, further comprising a panel mounting connector configured to secure one of the locking pin and the housing to a panel.

10. The magnetic-lock panel mounting assembly as recited in claim 9, wherein the panel mounting connector is connected to the housing.

11. The magnetic-lock panel mounting assembly as recited in claim 9, wherein the panel mounting connector is connected to the locking pin.

12. An architectural panel system, comprising:
a resin-based architectural panel having a front surface and an opposing rear surface; and
one or more magnetic-lock panel mounting assemblies securing the resin-based architectural panel to a support structure, each of the magnetic-lock panel mounting assemblies comprising:
a locking pin;
a housing configured to receive the locking pin therein;
a panel connector having a first end connected to the rear surface of the resin-based architectural panel, the panel connector having a second end connected to one of the locking pin and the housing; and
a magnetic locking mechanism configured to selectively lock the locking pin within the housing;
wherein at least a portion of the magnetic locking mechanism is magnetically attractable whereby a magnet placed against the front surface of the resin-based architectural panel opposite the magnetic locking mechanism automatically causes the magnetic locking mechanism to unlock the locking pin from the housing.

13. The architectural panel system as recited in claim 12, wherein the first end of the panel connector is embedded in the rear surface of the resin-based architectural panel.

14. The architectural panel system as recited in claim 13, wherein the front surface of the resin-based architectural panel is devoid of hardware.

15. The architectural panel system as recited in claim 13, further comprising a decorative image layer embedded in the resin-based architectural panel,
wherein the decorative image layer at least partially conceals the one or more magnetic-lock panel mounting assemblies from being viewed through the front surface of the resin-based architectural panel.

16. The architectural panel system as recited in claim 12, wherein the magnetic locking mechanism comprises:
a locking sleeve configured to move relative to one or more of the locking pin and the housing; and
one or more locking elements positioned between the locking sleeve and the locking pin.

17. The magnetic-lock panel mounting assembly as recited in claim 16, wherein:
the locking pin comprises one or more grooves;
when in a locked position, the locking sleeve forces the one or more locking elements into the one or more grooves; and
the one or more locking elements automatically move out of the one or more grooves when the locking sleeve is in an unlocked configuration.

18. The magnetic-lock panel mounting assembly as recited in claim 16, wherein the locking elements comprise ball bearings.

19. A method of dismounting a resin-based panel from a support structure, the resin-based panel being mounted to the support structure via a magnetic-lock panel mounting assembly, the method comprising:
placing a magnet proximate a front surface of the resin-based panel at a position opposite the magnetic-lock panel mounting assembly;
wherein a magnetic field of the magnet draws a locking sleeve of the magnetic-lock panel mounting assembly toward a rear surface of the resin-based panel thereby unlocking a locking pin of the magnetic-lock panel mounting assembly from a housing of the magnetic-lock panel mounting assembly; and
moving the resin-based panel away from the support structure and thereby pulling the locking pin out of the housing of the magnetic-lock panel mounting assembly.

20. The method as recited in claim 19, wherein movement of the locking sleeve toward the rear surface of the resin-based panel causes one or more ball bearings to automatically move out of one or more grooves in the locking pin.
